(19) United States
(12) Patent Application Publication
(10) Pub. No.: US 2021/0270593 A1
(43) Pub. Date: Sep. 2, 2021

(54) Angular position sensor with noise compensation

(71) Applicant: NETZER PRECISION MOTION SENSORS LTD., D.N. Misgav (IL)

(72) Inventors: Zohar Mann, Halfa (IL); Yishay Netzer, Yuvalim (IL)

(21) Appl. No.: 16/802,755

(22) Filed: Feb. 27, 2020

(51) Int. Cl. G01B 7/30; G01D 5/241

(52) U.S. Cl. CPC G01B 7/30; G01D 5/2415

(57) ABSTRACT

A capacitive angular position sensor, including a stationary disk and a rotary disk, the disks disposed parallel to each other and each having, on one of its faces, a patterned conductive layer, wherein the conductive layer on the stationary disk includes—a plurality of first electrodes, each capacitively coupled to at least a portion of the conductive layer on the rotary disk, the capacitive coupling being variable with the angular position,

a second electrode, formed as a ring and capacitively coupled with at least a portion of the conductive layer on the rotary disk and

a third electrode, formed as a ring and disposed so as to have capacitive coupling with the conductive layer on the rotary disk, the capacitive coupling being significantly lower than the capacitive coupling between the second electrode and the conductive layer on the rotary disk.

### BACKGROUND

The field of the present invention is angular position sensors and encoders (also known as rotary encoders or shaft encoders or angle transducers) and in particular—such sensors and encoders that utilize capacitive (or electrostatic) coupling and are therefore termed capacitive angular position sensors and encoders.

Capacitive angular position sensors (CAPS for short) serve to continuously measure the absolute angular position of a rotary body in a variety of electro-mechanical devices and systems. They utilize capacitive- or electrostatic coupling between electrodes on mutually adjacent discs that varies with the position to be sensed. Various structures and arrangements of such sensors are known. For example, U.S. Pat. No. 6,492,911 to the present applicant, incorporated herein by reference, discloses a capacitive angular position sensor (also termed motion encoder) that comprises at least one stationary disc (also referred to as stator), connected to a stationary part of a device and a rotary disc (also referred to as rotor), connected to the rotary body in the device; all the discs are disposed parallel and in close proximity to each other. One face of a first stationary disc includes electrodes plated thereon in a certain pattern, to serve as excitation (or transmitting) electrodes; the same face or a face of a second stationary disc also includes one or more electrodes plated thereon, to serve as receiving (or collection) electrodes. One or both faces of the rotary disc include one or more electrodes, termed transfer- or reflecting electrodes, formed thereon in another pattern. Alternating voltage signals (excitation signals) applied to the excitation electrodes induce corresponding charges in electrodes on the rotary disc, which, in turn, induce corresponding charges in the receiving electrodes; the latter charges are converted into corresponding received voltage signals by electronic circuitry coupled to the receiving electrodes. The electronic circuitry is designed so that the received signals are proportional to the effective capacitance between excitation electrodes and receiving electrodes (which results from the series combination of the capacitance between the rotary electrodes and, on the one hand, the corresponding excitation electrodes and, on the other hand, the corresponding receiving electrodes). The patterns of the various electrodes are designed so that the effective capacitance presented to each transmitted signal (and thus also the amplitude of the corresponding received signal) is related to the angular position of the rotary disc.

The structure and design of the various instances of CAPS offered commercially or proposed in the literature differ from one another, inter alia, in the number and nature of the excitation signals and in the patterns of the excitation electrodes and of the transfer electrodes. These relate mainly to the degree of resolution of the angular position, as well as to efficient use of space within the sensor.

It is noted that the output of the electronic circuitry is usually one or more voltages whose values are analogous to the angular position of the body. Therefore the name of apparatus that is the subject of the present invention includes the term “sensor”. Since, however, such apparatus may include additional circuitry that converts these voltages into digital signals, its name may include the term “encoder”. In what follows, the term “angular position sensor” will be used comprehensively, regardless of whether the output values are in analog or digital format.

It is further noted that, while the above example and the description to follow relate to angular position, the present invention is equally applicable, with obvious minor modifications, also to capacitive linear sensors and encoders, utilized to measure the linear position of a body along a given axis.

A problem frequently arising in the deployment of a capacitive position sensor is that ambient electric fields, such as emanate from the equipment to which it is coupled or from an adjacent motor or other apparatus, induce interfering signals in the electrodes of the sensor and, in particular, in the receiving electrodes. A major conduit for interfering fields may be the shaft through which the rotor is coupled to the rotary body. Such interfering signals combine in the electronic circuitry with the position-related signals and thus act to reduce the sensitivity, resolution and/or accuracy of the sensing process and to introduce errors into the output position values.

### SUMMARY OF THE INVENTION

There is provided, according to various embodiments of the invention, a capacitive angular position sensor for sensing an angular position between a rotary body and a stationary body, including a stationary disk, connected to the stationary body, and a rotary disk, connected to the rotary body,

the disks disposed parallel to each other and each having, on one of its faces, a patterned conductive layer,

wherein the conductive layer on the stationary disk includes—a plurality of first electrodes, each capacitively coupled to at least a portion of the conductive layer on the rotary disk, the capacitive coupling being variable with the angular position,

a second electrode, formed as a ring and capacitively coupled with at least a portion of the conductive layer on the rotary disk and

a third electrode, formed as a ring and disposed so as to have capacitive coupling with the conductive layer on the rotary disk, the capacitive coupling being significantly lower than the capacitive coupling between the second electrode and the conductive layer on the rotary disk.

In some embodiments the angular position sensor further includes electronic circuitry, connected to the second electrode and to the third electrode and is operative to receive signals electrically induced in the second electrode and in the third electrode, to amplify the signals and to subtract the amplified signal received from the third electrode from the amplified signal received from the second electrode.

In some of the embodiments the electronic circuitry is configured to enable adjusting the amplification factor of at least one of the signals so that any noise component in the results of the subtraction is reduced to an attainable minimum value and operative to process the results of the subtraction to yield corresponding angular position values.

In some embodiments the stationary disk is formed with a central hole and the rotary disc is mechanically coupled to a rotary shaft, which passes through the hole. In some of the embodiments the third electrode is nearer the center of the stationary disk than the first and second electrodes. The second electrode may be formed as a ring, interposed between the first electrode and the third electrode. The third electrode may be formed, at least in part, as plating on a rim of the hole.

There is also provided, according to other embodiments of the invention, a capacitive angular position sensor for sensing or encoding an angular position between a rotary body and a stationary body, including a first and second stationary disk, disposed parallel to each other and connected to the stationary body, and a rotary disk, disposed between the stationary disks and connected to the rotary body, each of the stationary disks having a patterned conductive layer on one of its faces, the conductive layers on the first and second stationary disks facing each other, wherein the conductive layer on the second stationary disk includes—one or more first electrodes, capacitively coupled with the conductive layer on the first stationary disk through the rotary disk, the coupling capacitance being variable with the angular position, and

a second electrode, formed as a ring and disposed so as to have capacitive coupling with the conductive layer on the first stationary disk that is significantly lower than any capacitive coupling between the first electrodes and the conductive layer on the first stationary disk.

In some embodiments the angular position sensor further includes electronic circuitry, connected to the first and second electrodes on the second stationary disk and operative to receive signals electrically induced in the first electrode and the second electrode, to amplify the signals and to subtract the amplified signal received from the second electrode from the amplified signal received from any of the receiving electrodes.

In some of the embodiments the electronic circuitry is configured to enable adjusting the amplification factor of at least one of the signals so that any noise component in the results of the subtraction is reduced to an attainable minimum value and operative to process the results of the subtraction to yield corresponding angular position values.

In some embodiments the second stationary disk is formed with a central hole and the rotary disc is mechanically coupled to a rotary shaft, which passes through the hole. In some of the embodiments one of the second electrodes is nearer the center of the second stationary disk than all of the first electrodes. The one second electrode may be formed, at least in part, as plating on a rim of the hole.

In some embodiments the rotor includes dielectric material, formed and configured to affect the variability of coupling capacitance.

There is also provided, according to the invention,

a method for sensing an angular position between a rotary body and a stationary body, including
providing a capacitive angular position sensor that includes
a set of first electrodes, plated on a first stationary disk,
a rotary disk that is mechanically coupled to the rotary body, and
a second electrode and a third electrodes, plated on the first stationary disk or on a second stationary disk,
the second electrode being capacitively coupled to the first electrodes through the rotary disk, the coupling capacitance being variable with angular position, and the third electrode having capacitive coupling with said first electrodes that is significantly lower than any capacitive coupling between the second electrode and the first electrodes;
applying signal voltages to the first electrodes;
obtaining induced signal voltages from the second and third electrodes and amplifying them;
subtracting the amplified signal obtained from the third electrode from the amplified signal obtained from the second electrode; and
processing the signal resulting from the subtracting to obtain an analog or digital representation of the angular position.

The method may further include
adjusting an amplification factor in the amplification of one of the signal voltages so that any noise component in the results of the subtraction is reduced to an attainable minimum value.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF THE DRAWINGS

FIGS. 1A-1C illustrate schematically an example embodiment of a two-discs configuration of the mechanical part of a CAPS according to the present invention, wherein

FIG. 1A is a cross-sectional top view of the assembly,

FIG. 1B is a face view of the stator and

FIG. 1C is a face view of the rotor.

FIGS. 2A-2D illustrate schematically an example embodiment of a three-discs configuration of the mechanical part of a CAPS according to the present invention, wherein

FIG. 2A is a cross-sectional top view of the assembly,

FIG. 2B is a face view of the excitation stator disc,

FIG. 2C is a face view of the rotor and

FIG. 2D is a face view of the receiver stator disc.

FIG. 3 is a schematic diagram of a circuit for subtracting a compensating signal from a received signal.

### DETAILED DESCRIPTION OF EXAMPLE EMBODIMENTS

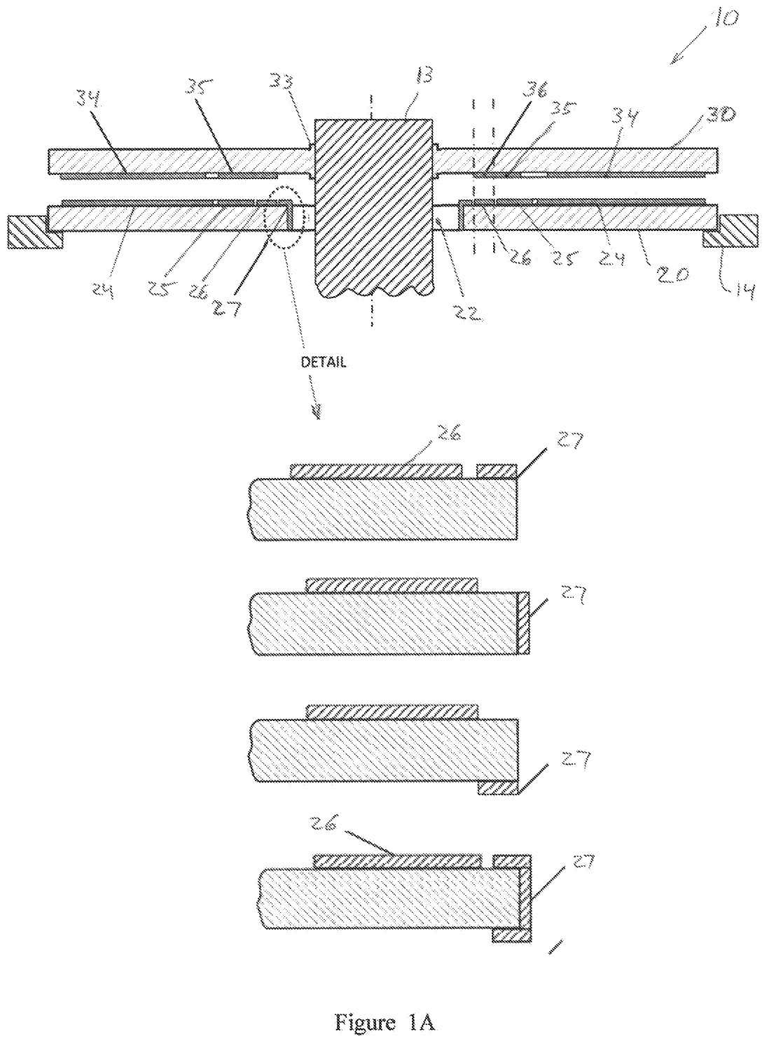

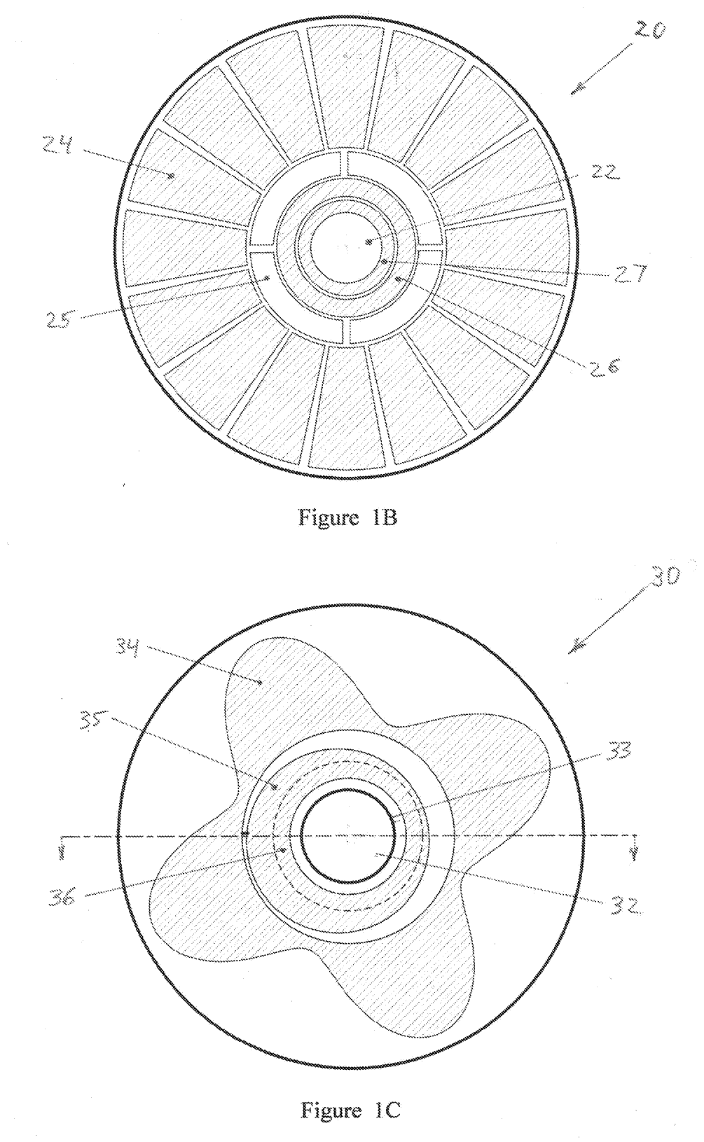

FIG. 1 presents schematically an example embodiment of a first configuration of the mechanical assembly 10 of a CAPS according to the invention. With reference to the cross-sectional top view in FIG. 1A, the assembly 10 includes a stationary disc (stator) 20, which may be rigidly connected to a frame or enclosure 14, and a rotary disc (rotor) 30, mounted on a shaft 13. The rotor 30 is formed with a central hole 32 (FIG. 1C), configured to be rigidly attached to the shaft 13; optionally a flange 33 surrounds the hole 32 for strengthening the attachment of the rotor 30 to the shaft 13. The shaft is coaxially connected or connectable to a rotary body whose angle is to be sensed, while the frame is attachable to any stationary member of a device or body that contains the rotary body. The two discs 20 and 30 are disposed parallel to each other and coaxial with the shaft 13, their faces being normal to the shaft axis. The thickness of each disc is typically 2 mm. The diameter of each disc is typically 60 mm, but may have any value—limited by a given overall size of the sensor. The distance between the discs is typically 1 mm. In the illustrated embodiment, the stator 20 has a central circular-cylindrical hole 22, whose diameter is larger than the diameter of the shaft 13, and is disposed so that the shaft passes through the hole, coaxially therewith. It is noted that the sectional plane of FIG. 1A is indicated in FIG. 1C, for example, by a horizontal dashed line with down pointing arrows at its ends.

The discs are made of a rigid non-conductive material, such as, for example, a material used for printed circuit boards. The inner faces of the discs, i.e. the faces nearest each other, are plated with a conductive layer, having a thickness of typically 0.1 mm, which is formed into variously shaped parts or segments, electrically isolated from each other, serving as electrodes, as discussed below. Some such segments, e.g. 24, 34 and 36, are seen in cross section in FIG. 1A. Generally, some parts or segments of the conductive layer on the stator 20 are transmitting electrodes, at least one other is a receiving electrode and another one is a compensation electrode; the pattern of the conductive layer on the rotor 30 constitutes transfer electrodes. During operation, electrical signals input to the transmitting electrodes are capacitively coupled to the transfer electrodes and thence to the receiving electrode. It is noted that, throughout the present disclosure, the terms “capacitively coupled” and “capacitive coupling”, as applied to a pair of members, imply the presence of corresponding electrical capacitance (herein also termed “coupling capacitance”) between the members. Furthermore, any adjectives accompanying these terms, such as “strong”, “weak”, “high”, “low”, “large”, “small” and “variable”, also in their relative forms (e.g. “stronger”, etc.), as well as adverbs derived therefrom, are to be understood as also applying to the corresponding capacitance.

FIG. 1B is a full view of the inner face of the stator 20, showing all the parts and segments of the conductive layer in their true shape, according to the illustrated example embodiment. They are seen to be radially arranged in four annular bands. The two inner bands, termed sensing electrodes, are formed each as a full ring, the two rings being isolated from each other. The radially innermost ring 27, which is considered to be a novel feature, is configured to serve as a compensation electrode, as will be explained below, where it will be also referred to as such. The other, next adjacent, ring 26 is configured to serve as a receiving electrode and will be also referred to as such below. It is noted that the deployment of the two rings, i.e. the sensing electrodes, in inner bands is advantageous, since, as will be explained, important functional considerations lead to the desirability of (a) these two electrodes being adjacent to each other and (b) the compensation electrode 27 being close to the shaft 13. However, in some embodiments one or both of these electrodes may also be deployed in an outer band (i.e. encircling the bands to be described next). The width of the receiving electrode 26 is typically 2 mm. The shape of the compensation electrode 27 will be discussed further below, but its overall width, as projected on the surface of the stator, is confined to an annular band whose width is typically 1 mm. It is noted that in some other embodiments, more than one receiving electrode and/or more than one compensation electrode may be deployed; in particular, in some embodiments the compensating electrode may consist of two separate rings, wherein one ring is nearest the center of the disc and the other ring is nearest the outer rim of the disc.

Preferably (as in the illustrated example embodiment) the design of the sensing electrodes (i.e. the receiving electrode 26 and the compensation electrode 27) is such that they are subject as equally as possible to the interfering fields and thus will have commensurately similar noise signals induced in them —enabling optimal noise cancellation in the processed received signal (as described below). It is noted that the interfering fields may vary in space not only in overall amplitude (which may easily be compensated for by differential amplification of the signals), but also in the relative amplitudes of various frequency components. Hence it is desirable that these two sensing electrodes be as close to each other. Also preferably (again as in the illustrated example embodiment) the compensation electrode 27 is placed as close to the shaft 13 as possible, since the latter is generally the main conduit through which electric noise is transmitted to the sensor (as any electric noise transmitted through the air is usually blocked by appropriate screening).

In the example embodiment the two electrodes are shaped as complete rings. Receiving electrode 26 is facing, and has good capacitive coupling with, the inner transfer electrode 35 (FIG. 1C) on the rotor—particularly with an annular region 36 thereof. Since the annular region 36 of that electrode is formed as a ring as well, the capacitive coupling between the two is maximal and substantially rotation independent.

In the illustrated example embodiment, the two outer bands on the face of the stator 20 are divided each into sectors. These sectors are designed to function as excitation electrodes and will be also referred to as such below. The excitation electrodes are connected to a driving circuit (not shown), as described below. The outermost band consists of sixteen sectors 24, designed to serve for fine angular position sensing, while the adjacent band consists of four sectors 25, designed to serve for coarse angular position sensing. In some other embodiments, the number of bands of excitation electrodes, as well as the number of sectors in each band, are different from those in the illustrated embodiments. Preferably, however, the entire pattern of excitation electrodes is such that they are confined to an annular band exclusive of the receiving- and compensation electrodes.

Referring again to FIG. 1A, there are shown, as enlarged detail in cross-sectional view, a part of the stator 20 near the hole 22 (delineated by a dashed ellipse) in four alternative configurations as examples. In each configuration are seen the receiving electrode 26, which is identical in all these configurations, and the compensation electrode 27, whose structure varies among the configurations. In the configuration illustrated by the topmost detail drawing, the compensation electrode 27 is simply a ring on the inner face. In the configuration next down, the electrode 27 is a plated layer on the rim of the hole 22, i.e. on the cylindrical surface bounding the hole; it has the advantage of clearing area on the face of the disc in favor of the other electrodes. In the configuration next down, the electrode is a ring on the opposite face of the stator; this also clears some space on the inner face. There are also configurations that combine the above-mentioned elements—for example, the top ring combined with the rim plating (not shown in detail, but appearing in the main drawing of FIG. 1A) or the three-element configuration illustrated by the bottom detail drawing. The advantage of such a combination is the increase of electrode surface without exceeding the allotted (inner) band on the inner face of the disc; this enables more of the interfering field to be captured by the compensation electrode.

FIG. 1C, is a full view of the inner face of the rotor 30, showing (with line hatching) the conductive layer as formed into two appropriately shaped electrodes, designed to serve as transfer electrodes and thus termed. The inner electrode 35 is designed to serve for coarse angular position sensing, while the outer electrode 34 is designed to serve for fine angular position sensing. They are shaped, sized and deployed so as to capacitively couple with corresponding bands of excitation electrodes on the stator 20; that is, the outer transfer electrode 34 is capacitively coupled to the outer band of excitation electrodes 24, while the inner transfer electrode 35 is capacitively coupled to the next band of excitation electrodes 25. The coupling capacitance between each of the transfer electrodes and each of the excitation electrodes (i.e. segments) in the corresponding band varies with the angular position of the rotor. The two electrodes are electrically interconnected and the inner electrode 35 is additionally shaped, sized and deployed so as to include an inner annular portion 36 that faces, and is capacitively coupled with, the receiving electrode 26 on the stator 20. It is noted that any capacitive coupling between the inner annular portion 36 and the compensation electrode 27 is significantly smaller than, i.e. less than half (preferably less than a quarter), the capacitive coupling between the inner annular portion 36 and the receiving electrode 26. This insures that the amplitude of the eventual sensed signal after subtracting the compensation signal (as described below) is not reduced enough to adversely affect the accuracy of the results.

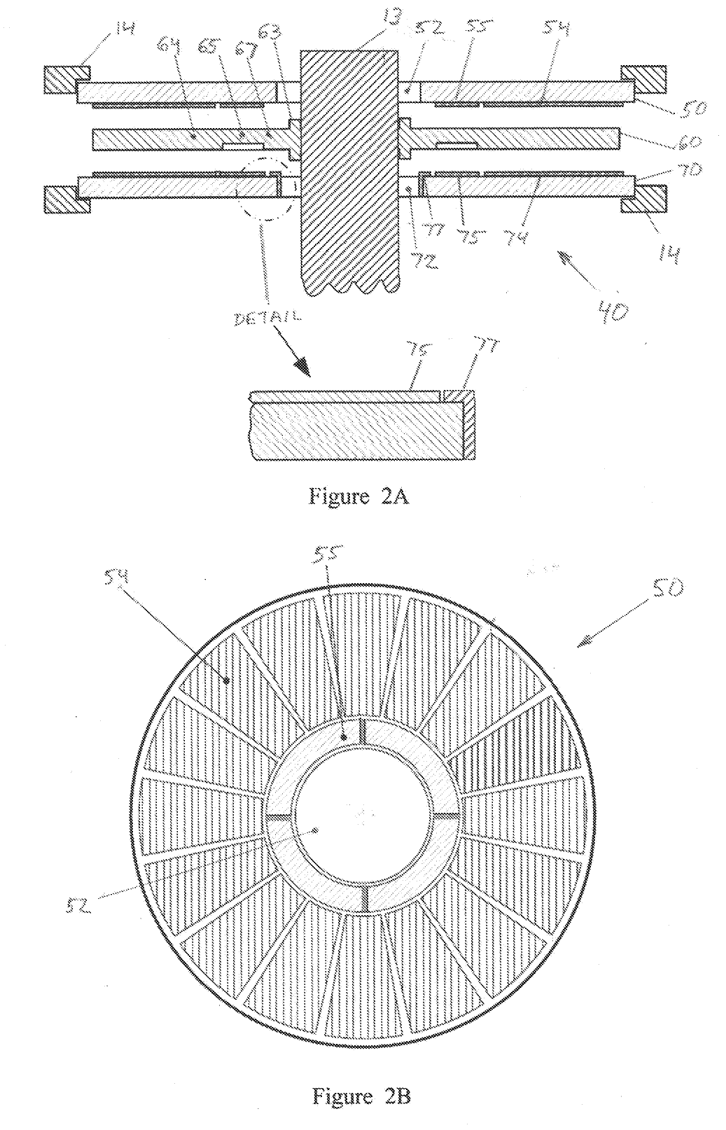

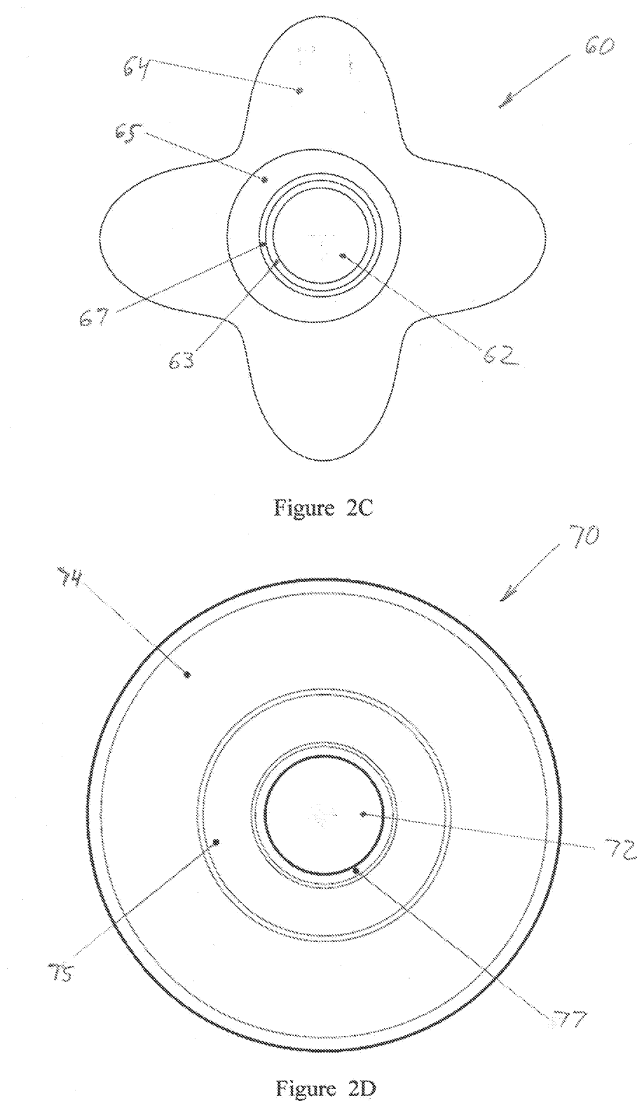

FIGS. 2A-2D present schematically an example embodiment of a second configuration 40 of the mechanical assembly of a CAPS according to the invention. It differs from the first configuration 10 in that it includes three, rather than two discs, namely two, rather than one, stators. As seen in the cross-sectional view of the assembly 40 in FIG. 2A, the two stators 50 and 70 are deployed parallel to the rotor 60 and straddling it, i.e. positioned near, and facing, mutually opposite faces of the rotor. The two stators are formed similarly to the stator 20 of the first configuration 10, except that a first stator 50 includes exclusively excitation electrodes, while the second stator 70 includes only receiving electrodes and a compensation electrode. Each of stators 50 and 70 is attached to a fixed frame 14 and has a central hole 52 and 72, respectively, to accommodate a shaft 13 passing therethrough. The rotor 60 in the example embodiment is made of a dielectric material (e.g. a polymer) and preferably has no conductive parts (in contrast with the rotor 30 of the first configuration 10). It is formed with a central hole 62 (FIG. 2C), configured to be rigidly attached to the shaft 13. Surrounding the hole 62 is a circular flange 63, which serves to strengthen the attachment of the rotor 60 to the shaft 13. Also seen in FIG. 2A is a region 65, within which the thickness of the disc is substantially smaller than outside it; its shape and function is explained below.

FIG. 2B shows the pattern of excitation electrodes on a face of the first stator 50. It is seen to be, in this example embodiment, similar to the pattern in FIG. 1B. Here, again, there are two annular bands—an outer one, consisting of excitation electrodes 54 associated with fine position sensing, and an inner one—consisting of excitation electrodes 55 associated with coarse position sensing. In other embodiments any other pattern may be deployed.

FIG. 2D shows a face of the second stator 70, with a pattern of two annular receiving electrodes 74 and 75, each deployed to be approximately congruent to a corresponding one of the bands of excitation electrodes on the first stator 50 and capacitively coupled thereto through the rotor 60. Additionally there is deployed on that face, preferably nearest its center, an annular (i.e. ring-shaped) compensation electrode 77. The compensation electrode 77 is radially positioned so that it has substantially lower capacitive coupling with any of the excitation electrodes on the first stator 50 than do the receiving electrodes 74 and 75—for the same reason given above with regard to compensation electrode 27 (on assembly 10). The receiving electrodes 74 and 75 and the compensation electrode 77 are also shown in cross-section in FIG. 2A.

FIG. 2C shows a face of the rotor 60 in the example embodiment of the second configuration 40. It has a star-like outline, which undulates between a maximum radius and a minimum radius. The maximum and minimum radii are preferably such that the annular region 64 between them (termed outer region) is approximately congruent with, and faces, the annular region of the high resolution transmitting electrodes 54 on the first stator 50. Inward from the minimum radius of that outline, and surrounding the hole, is an annular region 65 (termed inner region), whose outline has a radius that varies over a full circle between a maximum radius and a minimum radius; thus the radial dimension of the region 65 varies correspondingly. This region is approximately congruent with, and faces, the annular region of the low resolution transmitting electrodes 55 on the first stator 50. As can be seen in FIG. 2A, the thickness of the rotary disc 60 (which, as stated above, is made of a dielectric material) within the region 65—typically 1 mm—is substantially smaller than outside the region, where it is typically 2 mm. In other embodiments, the thickness within the region may be greater than outside it; generally the two thicknesses should be substantially different from each other. Between the thin region 65 and the flange 63 lies an innermost annular region 67, positioned to face the compensation electrode 77 on second stator 70.

The rotor 60 affects the capacitance, and therefore also the capacitive coupling, between each of the excitation electrodes on the first stator 50 and the receiving electrodes on the second stator 70 by its dielectric effect. The capacitance varies with the angular position of the rotor (and thus—of the rotational body), between some highest value and some lowest value; this angular variation is a function of the outline of the rotor disc 60 (i.e. of the outer region 64) for fine position sensing and of the inner region 65 for coarse position sensing. Thus the capacitive coupling between each outer-band excitation electrode 54 and the receiving electrode 74 varies with the position angle as a direct function of the relative area of the thick outer region 64 of rotor 60 that lies between them. Similarly the capacitive coupling between each inner-band excitation electrode 55 and the receiving electrode 75 varies with the position angle as an inverse function of the relative area of the thin inner region 65 of rotor 60 that lies between them. It is noted that the compensation electrode 77, though positioned near the innermost region 67 of the rotor (which is of dielectric material as well), does not face an excitation electrode; thus its capacitive coupling with the excitation electrodes 54 and 55 is significantly lower than the capacitive coupling between the receiving electrodes 74 and 75 and the corresponding excitation electrodes, i.e. any capacitance between compensation electrode 77 and an excitation electrode 54 or 55 is less than half (preferably less than a quarter) the lowest value of capacitance between that excitation electrode and a corresponding receiving electrode 74 or 75. This, again, insures that the amplitude of the eventual sensed signal after subtracting the compensation signal (as described below) is not reduced enough to adversely affect the accuracy of the results.

In some other embodiments (not illustrated) the rotor is made of material similar to that of the stators 50 and 70, has uniform thickness and is plated with two pairs of transfer electrodes, each pair deployed identically on both faces of the rotor and electrically interconnected. One member of each pair faces a corresponding band of excitation electrodes 54 or 55 while the other member faces a corresponding receiving electrode 74 or 75. Thus each pair of transfer electrodes provides capacitive coupling (as two capacitors in series, with commensurate effective capacitance) between corresponding electrodes on the two stators. The member of each pair that faces an excitation electrode is shaped and positioned similarly to a corresponding region 64 or 65 on the illustrated embodiment of rotor 60, so as to capacitively couple each band of excitation electrodes on the first stator with a corresponding receiving electrode on the second stator, wherein the capacitance varies with the angular position of the rotor, thus serving for fine and coarse position sensing, respectively. The other member of each pair of transfer electrodes on the rotor (i.e. the one facing a receiving electrode) is, in some embodiments, shaped similarly to the first member, while in other embodiments it is shaped as an annular ring, similar to the corresponding receiving electrode 74 or 75. It is noted that compensation electrode 77 has, again, minimal capacitive coupling with all the other electrodes, i.e. its effective capacitance with the excitation electrodes 54 or 55 is substantially smaller than that of the receiving electrodes 74 and 75.

With regard to the embodiments described above, as well as any alternative embodiments, all excitation electrodes are electrically connected to corresponding output terminals of a provided electrical driving unit (not shown), which is designed and operative to apply to the excitation electrodes appropriate excitation signal voltages, adapted for the particular pattern of excitation electrodes deployed. The nature of the signal and the manner of its generation are similar to those used in CAPS of prior art, disclosed, for example, in U.S. Pat. No. 6,492,911. Also in common with prior art and as disclosed, for example, in U.S. Pat. No. 6,492,911, there is provided an electrical processing unit (not shown), with input terminals connected to corresponding receiving electrodes, which is operative to amplify signals electrically (e.g. capacitively) induced in the receiving electrodes and to process them so as to obtain an electrical analog of the angular position of the rotor. Optionally and again as known from prior art, an analog-to digital converter is provided, operative to convert this electrical analog into a corresponding digital representation of the angular position, thus rendering the whole apparatus to be an angular position encoder.

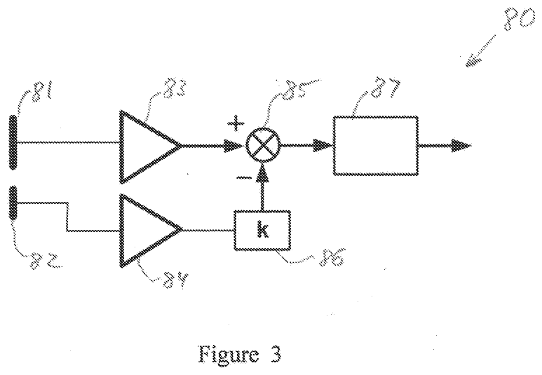

The processing unit according to example embodiments of the present invention includes also a compensation circuit, interjected at one or more stages of amplification in each channel of processing (if more than one), and is operative to receive also a signal electrically induced in the compensation electrode (mainly by interfering, or noise, fields), to amplify the signals received from the receiving electrodes and from the compensation electrode, with generally different amplification factors, and to subtract one from the other. FIG. 3 shows schematically an example embodiment of a single such compensation circuit within a processing unit 80. Received signal is obtained from a receiving electrode 81, amplified by amplifier 83 and applied to one input of subtractor 85. Compensation signal is obtained from a compensation electrode 82, amplified by amplifier 84, multiplied by a factor k in an adjustable attenuator 86 and applied to the second input of subtractor 85. The output of subtractor 85 is applied to a processor 87. The attenuator 86 is configured to enable adjusting the factor k so that any noise signal originating from electrical noise near the sensing electrodes (26 and 27 in FIG. 1B, 74, 75 and 77 in FIG. 2D) and appearing in the output of subtractor 85 is reduced to an attainable minimum or practically null value. This value is a function of the similarity between the noise signals induced in the compensation electrode and in the receiving electrodes (except for a constant scale factor). Thus the output of subtractor 85 is a signal that very faithfully represents the angular position of the rotor and, as such, is input to the processor 87 (which represents the rest of the circuitry of the processing unit 80) for processing as is known from prior art. It is noted that other embodiments of a compensation circuit are possible, using any means known in the art, provided that they are operative to perform the function described herein.

When more than one compensation electrode is deployed (as may be the case in some embodiments), the compensation circuit may have corresponding additional input terminals, connected to them. In some embodiments the processing unit may include a plurality of compensation circuits, such as described above, and is generally operative to amplify voltages capacitively induced in the various sensing electrodes and to subtract the amplified voltage originating in the compensating electrode from amplified voltages originating in any of the receiving electrodes or a combination of such voltages—all with appropriately adjusted amplification—or attenuation—factors.

It will be appreciated that, similarly to signals obtained in conventional angular position sensors and encoders, the results of the compensation and the further signal processing—whether in terms of voltages or in digital form—are analogous to the angular position of the rotary body and may be readily translated into actual angle values. However, unlike conventional sensors and encoders, the resultant angular position values have minimal or practically no error.

It will also be appreciated that the above descriptions are intended only to serve as examples and that many other embodiments are possible within the scope of the present invention as defined in the appended claims.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

1. A capacitive angular position sensor for sensing an angular position between a rotary body and a stationary body, comprising a stationary disk, connected to the stationary body, and a rotary disk, connected to the rotary body,
said disks disposed parallel to each other and each having, on one of its faces, a patterned conductive layer,
wherein the conductive layer on the stationary disk includes—a plurality of first electrodes, each capacitively coupled to at least a portion of the conductive layer on the rotary disk, the capacitive coupling being variable with the angular position,
a second electrode, formed as a ring and capacitively coupled with at least a portion of the conductive layer on the rotary disk and
a third electrode, formed as a ring and disposed so as to have significantly lower capacitive coupling with the conductive layer on the rotary disk than the capacitive coupling between said second electrode and the conductive layer on the rotary disk.

2. An angular position sensor as in claim 1, further comprising electronic circuitry, connected to said second electrode and to said third electrode and operative to receive signals electrically induced in said second electrode and in said third electrode, to amplify said signals and to subtract the amplified signal received from said third electrode from the amplified signal received from said second electrode.

3. An angular position sensor as in claim 2, wherein the electronic circuitry is configured to enable adjusting the amplification factor of at least one of said signals so that any noise component in the results of said subtraction is reduced to an attainable minimum value and operative to process the results of said subtraction to yield corresponding angular position values.

4. An angular position sensor as in claim 1, wherein the stationary disk is formed with a central hole and the rotary disc is mechanically coupled to a rotary shaft, which passes through said hole.

5. An angular position sensor as in claim 4, wherein said third electrode is nearer the center of the stationary disk than said first and second electrodes.

6. An angular position sensor as in claim 5, wherein said second electrode is formed as a ring, interposed between said first electrode and said third electrode.

7. An angular position sensor as in claim 5, wherein said third electrode is formed, at least in part, as plating on a rim of said hole.

8. A capacitive angular position sensor for sensing an angular position between a rotary body and a stationary body, comprising a first stationary disk and a second stationary disk, disposed parallel to each other and connected to the stationary body, and
a rotary disk, disposed between said stationary disks and connected to the rotary body, each of said stationary disks having a patterned conductive layer on one of its faces, the conductive layers on said first and second stationary disks facing each other, wherein the conductive layer on the second stationary disk includes—one or more first electrodes, capacitively coupled with the conductive layer on the first stationary disk through the rotary disk, the coupling capacitance being variable with the angular position, and
a second electrode, formed as a ring and disposed so as to have a significantly lower capacitive coupling with the conductive layer on the first stationary disk than the lowest capacitive coupling between said first electrodes and the conductive layer on the first stationary disk.

9. An angular position sensor as in claim 8, further comprising electronic circuitry, connected to said first and second electrodes on the second stationary disk and operative to receive signals electrically induced in said first electrode and said second electrode, to amplify said signals and to subtract the amplified signal received from said second electrode from the amplified signal received from any of said receiving electrodes.

10. An angular position sensor as in claim 9, wherein the electronic circuitry is configured to enable adjusting the amplification factor of at least one of said signals so that any noise component in the results of said subtraction is reduced to an attainable minimum value and operative to process the results of said subtraction to yield corresponding angular position values.

11. An angular position sensor as in claim 8, wherein the second stationary disk is formed with a central hole and the rotary disc is mechanically coupled to a rotary shaft, which passes through said hole.

12. An angular position sensor as in claim 11, wherein one of said second electrodes is nearer the center of the second stationary disk than all of said first electrodes.

13. An angular position sensor as in claim 12, wherein said one of the second electrodes is formed, at least in part, as plating on a rim of said hole.

14. An angular position sensor as in claim 8, wherein the rotor includes dielectric material, formed and configured to affect said variability of coupling capacitance.

15. A method for sensing or encoding an angular position between a rotary body and a stationary body, comprising—
providing a capacitive angular position sensor that includes
a set of first electrodes, plated on a first stationary disk,
a rotary disk that is mechanically coupled to the rotary body, and
a second electrode and a third electrodes, plated on the first stationary disk or on a second stationary disk,
said second electrode being capacitively coupled to said first electrodes through the rotary disk, the coupling capacitance being variable with angular position, and said third electrode having significantly lower capacitive coupling with said first electrodes than the lowest capacitive coupling between said second electrode and said first electrodes;
applying signal voltages to said first electrodes;
obtaining induced signal voltages from said second and third electrodes and amplifying them;
subtracting the amplified signal obtained from the third electrode from the amplified signal obtained from the second electrode; and
processing the signal resulting from said subtracting to obtain an analog or digital representation of the angular position.

16. The method of claim 15, further comprising—
adjusting an amplification factor in the amplification of one of said signal voltages so that any noise component in the results of said subtraction is reduced to an attainable minimum value.
